(19) United States
(12) Patent Application Publication
(10) Pub. No.: US 2026/0302029 A1
(43) Pub. Date: Oct. 1, 2026

(54) Device and system for retrieving firearm shells

(71) Applicant: Robert Del Adams, Waller, TX (US)

(72) Inventor: Robert Del Adams, Waller, TX (US)

(21) Appl. No.: 18/831,479

(22) Filed: Feb. 18, 2025

(51) Int. Cl. H01F 7/02

(52) U.S. Cl. CPC H01F 7/0257

(57) ABSTRACT

A system for retrieving firearm shells, comprises providing a magnetic device configured to attach to the tip of the firearm barrel, the magnetic device comprising a tube designed to slip onto the firearm, and to remain unobtrusively in place, and at least one magnetic element attached to the tube.

### BACKGROUND

The present disclosure relates generally to systems and devices for hunting.

Collecting shell casings while hunting may be a tedious task, which many hunters may neglect. As such, an improved methods which allows the casings to be picked up with ease is desirable.

### SUMMARY

According to various embodiments, disclosed is a system for retrieving firearm shells, which comprises providing a magnetic device configured to attach to the end of a firearm barrel. In some embodiments, the magnetic device may comprise a tube designed to slip onto the firearm and to remain unobtrusively in place via friction, and at least one magnetic element attached to the outer side of the tube. In certain embodiments, the tube may be a PVC tube.

### BRIEF DESCRIPTION OF THE FIGURES

The detailed description of some embodiments of the invention will be made below with reference to the accompanying figures, wherein the figures disclose one or more embodiments of the present invention.

FIG. 1 shows a magnetic device configured to attach to the end of a firearm barrel for picking up shell casings, according to various embodiments.

FIG. 2 shows the magnetic device attached to the end of a shotgun barrel.

### DETAILED DESCRIPTION OF CERTAIN EMBODIMENTS

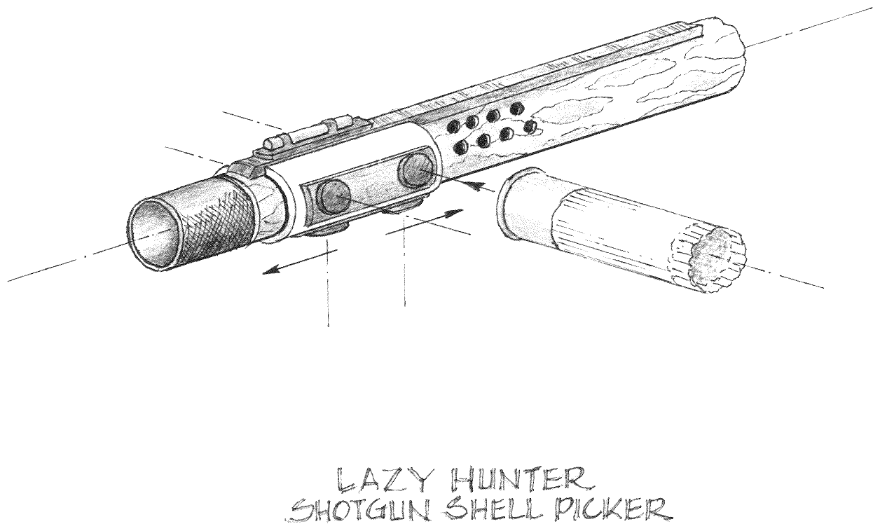

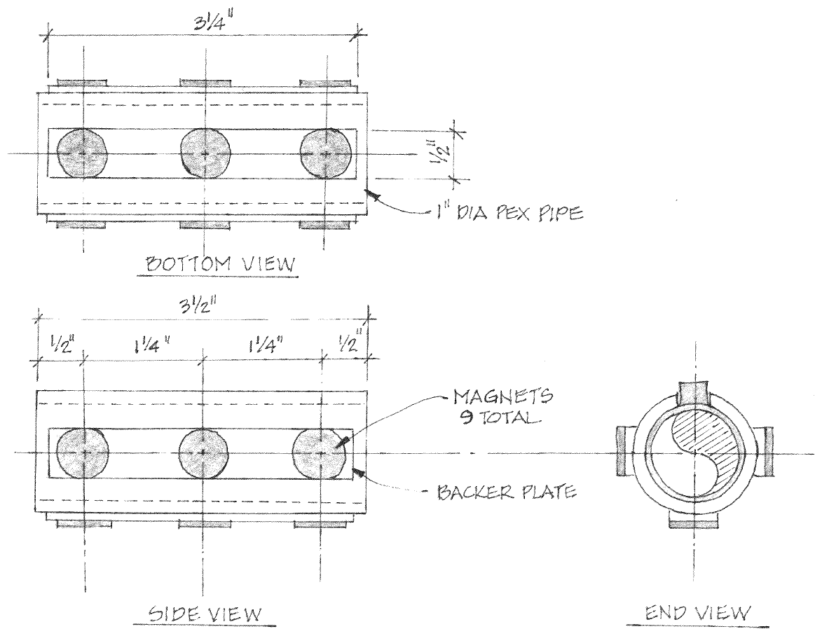

According to various embodiments as depicted in FIGS. 1 and 2 disclosed is a device and system for retrieving firearm shells, which comprises providing a magnetic device configured to attach to the tip of the firearm barrel. In embodiments, the device comprises a tube designed to slip onto the firearm, and to remain unobtrusively in place. As such, the user, i.e., hunter, may collect shells while using the firearm. In embodiments, the device may ideally be used with firearms having a long barrel, such as hunting shotguns, as the length of the firearm allows the user to easily collect shells with minimal to no bending.

According to an exemplary embodiment, the magnetic device may comprise a PVC tube with one or more magnets provided on the outer side of the tube. The PVC tube is sized to slip onto the barrel with a snug fit, and to remain in place via friction. The PVC material provides a tight grip to the barrel with minimal slippage from recoil. It shall be appreciated however, that different materials may be used for the tube in alternate embodiments. In one alternate embodiment, light aluminum tubing may be used instead of PVC. Additionally, various attachment elements/mechanisms may be used to attach the tube to the barrel and/or to reinforce attachment in alternate embodiments. Such alternate attachment elements/mechanisms may include gluing, welding, etc.

In certain embodiments, the magnets may comprise flat magnetic plates supporting a number of magnetic discs, as shown in the figures. The plat plates are distributed around the circumference of the tube, and are configured to provide a magnetic field strong enough to pick up the shells. In some embodiments, the magnets/flat magnetic plates may be glued to the tube, for example, using a silicone-based adhesive. It shall be appreciated that the magnets may be of different geometries in alternate embodiments, and that any number of magnets of various sizes may be used in alternate embodiments.

In use, the device may be slid or pressed onto the barrel of a firearm, such as a 12 gauge or 20 gauge shotgun, and may remain in place while firing the shotgun. This allows the user to pick up shells right after firing the gun, with minimal or no bending, and without requiring the user to carry or retrieve a separate device such as a magnet stick.

As such, the disclosed system provides magnets on the barrel of the shotgun at all times, making it very convenient for picking up shell casings. The device may be slipped onto the gun barrel, and remain in place, so that the hunter always has it available for picking up casings while hunting. As the device may be left on the shotgun indefinitely, there is no risk that the hunter will forget to carry it along with the shotgun, assuring that the hunting area is left clean.

It shall be appreciated that the disclosed device and system can have multiple configurations in different embodiments. For example, the disclosed system may provide a factory made firearm with magnetic tube and/or magnetic element pre-attached to the barrel tip in alternate embodiments. It shall be appreciated that the device and system described herein may comprise any alternative known materials in the field and be of any color, size, and/or dimensions. It shall be appreciated that the device may be manufactured and assembled using any known techniques in the field.

It shall be understood that the orientation or positional relationship indicated by terms such as “upper”, “lower”, “front”, “rear”, “left”, “right”, “top”, “bottom”, “inside”, “outside” is based on the orientation or positional relationship shown in the accompanying drawings, which is only for convenience and simplification of describing the disclosed subject matter, rather than indicating or implying that the indicated device or element must have a specific orientation or are constructed and operated in a specific orientation, and therefore should not be construed as a limitation of the present invention.

As used herein, the articles “a” and “an” are intended to include one or more items, and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/−10%. Relationships between the various elements of the disclosed device as described herein are presented as illustrative examples only, and not intended to limit the scope or nature of the relationships between the various elements. Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for retrieving firearm shells, comprising:
providing a magnetic device configured to attach to the tip of a firearm barrel, the magnetic device comprising a tube designed to slip onto the barrel and to remain unobtrusively in place, and at least one magnetic element attached to the tube.

2. The system of claim 1, wherein the tube is a PVC tube.
